(19) United States
(12) Patent Application Publication
(10) Pub. No.: US 2025/0103387 A1
(43) Pub. Date: Mar. 27, 2025

(54) DOUBLE-HELIX SCHEDULING METHOD FOR SOUNDCARD BUFFERS DURING SOUND RECORDING AND REPRODUCTION

(71) Applicant: ZHEJIANG UNIVERSITY OF TECHNOLOGY, Zhejiang (CN)

(72) Inventors: Chenggang LU, Zhejiang (CN); Zhe NAN, Zhejiang (CN); Ziqiang SHEN, Zhejiang (CN); Lizhong YANG, Zhejiang (CN); Bin WANG, Zhejiang (CN); Gaoyue LONG, Zhejiang (CN); Xiaodi BAI, Zhejiang (CN)

(73) Assignee: ZHEJIANG UNIVERSITY OF TECHNOLOGY, Zhejiang (CN)

(21) Appl. No.: 18/741,790

(22) Filed: Jun. 13, 2024

(30) Foreign Application Priority Data
Sep. 21, 2023 (CN) 202311220471.9
May 10, 2024 (CN) 202410578840.X

(51) Int. Cl. G06F 9/48; G06F 3/16; G06F 13/16

(52) U.S. Cl. CPC G06F 9/4881; G06F 3/16; G06F 13/1673

(57) ABSTRACT

Provided is a double-helix scheduling method for soundcard buffers during sound recording and reproduction, which belongs to the technical field of multimedia communication. The method includes steps as follows: step 1: preparing N frame buffers for each process of the sound recording and the sound reproduction; step 2: adding N sound recording buffers in a sound card, and starting the sound recording; and writing N sound reproduction buffers in the sound card one by one, then starting the sound playing; step 3: writing sound reproduction buffers in the sound card in a sound recording callback function; step 4: adding sound recording buffers in a sound reproduction callback function; and step 5: finishing the sound recording and the sound reproduction.

### CROSS-REFERENCE TO RELATED APPLICATION

This application claims both the priority benefits of China application serial no. 202311220471.9, filed on Sep. 21, 2023 and China application serial no. 202410578840.X, filed on May 10, 2024. The entirety of each of the above-mentioned patent applications is hereby incorporated by reference herein and made a part of this specification.

### TECHNICAL FIELD

The present disclosure belongs to the technical field of multimedia communication, and particularly relates to a double-helix scheduling method for soundcard buffers during sound recording and reproduction.

### BACKGROUND

A sound card is one of the principal peripherals in the technical field of computer multimedia. Besides PCB layout integrated sound cards, other independent sound cards are mostly integrated in the form of peripheral component interconnect (PCI) cards. When a computer processes real-time audio, transfer scheduling of a data cache block is performed between an operating system and the sound card through direct memory access (DMA). That is, a bidirectional data exchange of reading and writing is performed between the sound card and the DMA through hardware interrupt, synchronously a bidirectional data exchange is performed between the operating system and the DMA. Thus, it is helpful to retard the CPU heavy workload from a sound card hardware interrupt response request, and improve scheduling efficiency of the operating system.

However, such a processing method increases latencies of sound recording and reproduction. A buffer through the DMA managed by OS is called a core state buffer, and a memory exchanged by the operating system with the core state buffer is called an application state buffer. The sound recording and reproduction cannot be continued if the application state buffer is too small, but if the application state buffer is larger, the longer system latency will be caused. It is necessary to read and write audio of the sound card at the expense of a certain latency on a computer with an operating system. However, it is inevitable to produce scheduling jitter. Moreover, a crystal oscillator of the sound card will be aged, and jitter noise is unique to a digital system, which will affect the sound recording and reproduction to a certain extent. For example, a large jitter amplitude will destroy temporal uniformity of audio sampling and distort a physical frequency of a sound, and more severely, audible discontinuity of a sound generation in time domain will be caused. Generally speaking, a large size of the application state buffer can avert such a jitter effect to a certain degree, especially if a buffer is long enough.

However, in duplex voice communication and other scenarios, echo cancellation processing of a sound recording signal is generally required to be performed with reference to and in combination with a sound reproduction signal due to a working principle of an acoustic echo cancellation module. In this case, how to avert asynchronism of two-channel audio caused by system jitter is a significant guarantee of performance. In practice, a certain synchronization guarantee is required if one channel is required to serve as reference for the other channel. Similarly, the above problems also exist when multi-channel microphones collected signals are considered for sound source localization.

### SUMMARY

In view of the above problems in the prior art, an objective of the present disclosure is to provide a double-helix scheduling method for soundcard buffers during sound recording and reproduction, which can passively dynamically synchronize two channels of signals of the sound recording and the sound reproduction according to a working principle of a preemption mode of the sound card.

The present disclosure provides a technical solution as follows: a double-helix scheduling method for soundcard buffers during sound recording and reproduction. The method includes steps as follows:
step 1: preparing N frame buffers for each process of the sound recording and the sound reproduction;
step 2: adding N sound recording buffers in a sound card, and starting the sound recording; and writing N sound reproduction buffers in the sound card one by one, and then starting the sound playing;
step 3: writing sound reproduction buffers in the sound card in a sound recording callback function;
step 4: adding sound recording buffers in a sound reproduction callback function; and
step 5: finishing the sound recording and the sound reproduction.

Further, specific instructions in step 2 are serial in sequence.

Further, in step 2, the sound recording buffer is empty, and to be filled. The sound reproduction buffer is filled by means of a network incoming audio data or through audio file reading and then is written in the sound card.

Further, a specific process of step 3 is as follows:
writing N buffers marked with i in a sound reproduction buffer queue in the sound card in the sound recording callback function, where i starts from 0, i increases by 1, and i is reset as 0 after being equal to N.

Further, a specific process of step 4 is as follows:
adding N buffers marked with j in a sound recording buffer queue in the sound reproduction callback function, where j starts from 0, j increases by 1, and j is reset as 0 after being equal to N.

Further, in step 3 and step 4, before the N buffers marked with i in the sound reproduction buffer queue are written in and the N buffers marked with j in the sound recording buffer queue are added in the sound card, a sub-thread is started, and multi-thread scheduling of the sound recording and reproduction is constructed.

Further, when a signal of real-time sound reproduction is processed, the buffers marked with i in step 3 are required to be taken out for processing before being added in the sound reproduction buffer queue, and a processing result is saved.

When a signal of real-time sound recording is processed, the buffers marked with j in step 4 are required to be processed before being added in the sound card.

Further, in step 3 and step 4, the sound recording callback function and the sound reproduction callback function each write sound reproduction buffers in or add sound recording buffers in the sound card. After the sound recording buffers are added in and the buffers are written in the sound card, it is capable of calling a corresponding sound recording callback function and sound reproduction callback function. Calls of the sound recording callback function and the sound reproduction callback function, writing of sound reproduction buffers in the sound card in the sound recording callback function, and addition of sound recording buffers in the sound reproduction callback function are repeatedly circulated until the sound recording and the sound reproduction are finished.

### BRIEF DESCRIPTION OF THE DRAWINGS

FIG. 1 is a system block diagram of an overall method according to the present disclosure.

FIG. 2 is a schematic diagram of a principle of a case that calls of a sound recording callback function and a sound reproduction callback function, writing of sound reproduction buffers in a sound card in the sound recording callback function, and addition of sound recording buffers in the sound reproduction callback function are repeatedly circulated in step 3 and step 4 according to the present disclosure.

FIG. 3 is a schematic diagram of analogy between sound recording and reproduction timelines and a deoxyribonucleic acid (DNA) structure according to the present disclosure.

### DETAILED DESCRIPTION OF THE EMBODIMENTS

In order to make the objectives, technical solutions and advantages of the present disclosure clearer and more understandable, the present disclosure will be further described in detail below in combination with the accompanying drawings and examples. It should be understood that the particular examples described herein are merely intended to explain the present disclosure but not to limit the present disclosure.

On the contrary, the present disclosure contains any substitutions, modifications, equivalent methods and solutions made within the spirit and scope of the present disclosure as defined by the claims. Further, in order to enable the public to better understand the present disclosure, certain specific details are described in the following detailed description of the present disclosure. Those skilled in the art would also fully understand the present disclosure without the descriptions of these details.

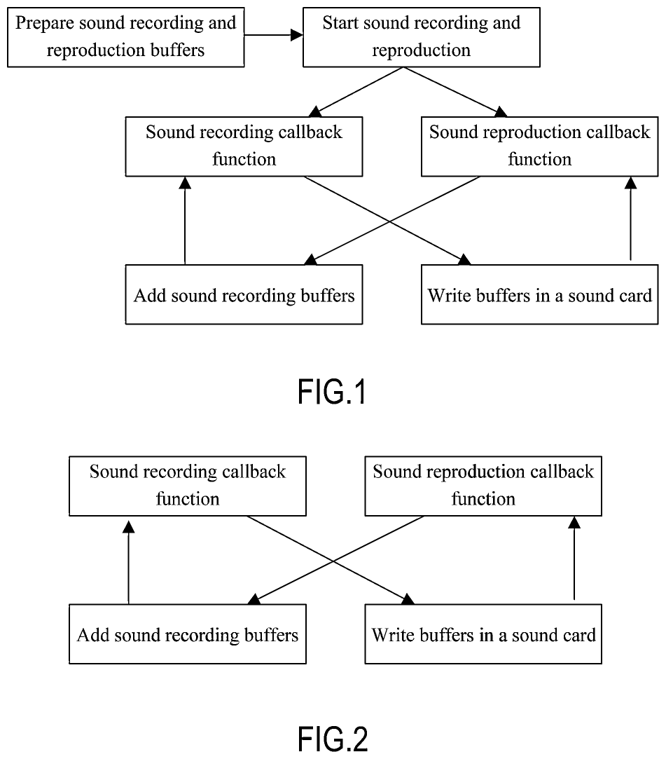

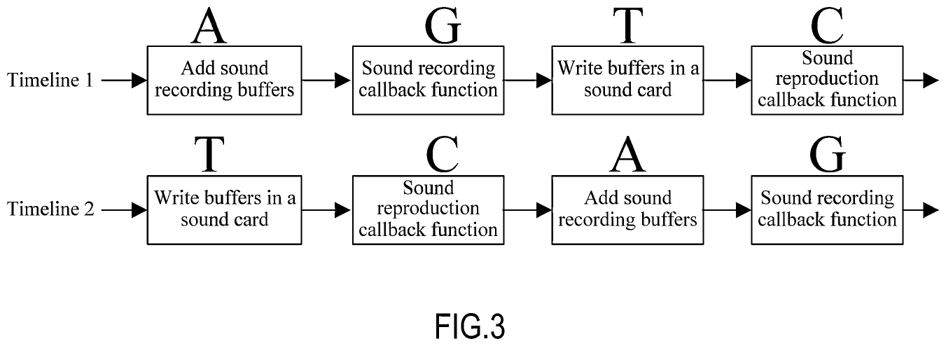

With reference to FIG. 1-FIG. 3:

### Example 1

A double-helix scheduling method for soundcard buffers during sound recording and reproduction includes steps as follows:
Step 1: prepare N frame buffers for each process of the sound recording and the sound reproduction.
Step 2: add N sound recording buffers in a sound card, and start the sound recording; and write N sound reproduction buffers in the sound card one by one, and then start the sound playing. Specific sub-steps of step 2 are serial in sequence. In the step, the sound recording buffer is empty, and to be filled. The sound reproduction buffer is filled by means of a network incoming audio data or through audio file reading and then is written in the sound card.
Step 3: write N buffers marked with i in a sound reproduction buffer queue in the sound card in the sound recording callback function, where i starts from 0, i increases by 1, and i is reset as 0 after being equal to N.
Step 4: add N buffers marked with j in a sound recording buffer queue in the sound reproduction callback function, where j starts from 0, j increases by 1, and j is reset as 0 after being equal to N.
Step 5: finish the sound recording and the sound reproduction.

In step 3 and step 4, if a signal processing module is required to process signals of real-time sound recording and sound reproduction, for instance, carry out filtration before play, noise reduction after sound recording, or echo cancellation, the buffers marked with i in step 3 are only required to be taken out or processing before being added in the sound recording buffer queue, and a processing result is saved, which is processing before play; or the buffers marked with j in step 4 are processed before being written in the sound card, which is post-sound-recording filtration.

Further, in step 3 and step 4, the sound recording callback function and the sound reproduction callback function each write sound reproduction buffers in or add sound recording buffers in the sound card. After the sound recording buffers are add in and the buffers are written in the sound card, a corresponding sound recording callback function and sound reproduction callback function are capable of being called. Calls of the sound recording callback function and the sound reproduction callback function, writing of sound reproduction buffers in the sound card in the sound recording callback function, and addition of sound recording buffers in the sound reproduction callback function are repeatedly circulated until the sound recording and the sound reproduction are finished.

### Example 2

A difference between the Example and Example 1 lies in that:

in step 3 and step 4, before the N buffers marked with j in the sound reproduction buffer queue are written in and the N buffers marked with i in the sound recording buffer queue are added in the sound card, a sub-thread is started, and multi-thread scheduling of the sound recording and reproduction is constructed.

Since the two callback functions are blocking and cannot be executed for too long time, it is convenient to insert a signal processing filtration module when operations of “addition of sound recording buffers” and “writing of buffers in a sound card” are carried out in a multi-thread mode.

The following table shows an instance of an operation result. A frame length of sound recording and sound reproduction of a program design specification is 20 milliseconds (ms).

| | | | Average time delay | | |
|---|---|---|---|---|---|
| | Frame number | Frame number | difference of sound | Frame length | Frame length |
| Test | of sound | of sound | recording and sound | of sound | of sound |
| number | recording | reproduction | reproduction per frame | recording | reproduction |
| 1 | 248 | 251 | 0.21223000 | 20.13263400 | 20.16364200 |
| 2 | 711 | 711 | 0.07296500 | 20.07342500 | 20.00046000 |
| 3 | 959 | 958 | 0.20135500 | 20.23413400 | 20.01176300 |
| 4 | 1789 | 1779 | 0.19903100 | 20.44416600 | 20.13208700 |
| 5 | 2466 | 2466 | 0.19416000 | 20.19845700 | 20.00429700 |

It can be seen from 5 experiments in the above table that due to the existence of scheduling jitter, an average frame length will not be exactly 20 milliseconds. Secondly, synchronization of sound recording and sound reproduction is improved compared with that in a conventional mode. Consistency of frame numbers of sound recording and sound reproduction are far better than that in the conventional mode (in which a total frame number difference is 14 frames), it can be seen that when the two are synchronized, the consistency of the frame numbers will affect performance of the signal processing filtration module, especially an acoustic echo cancellation module, etc. An update frequency of an echo filter is not reduced or increased, because the frame number of sound recording basically matches the frame number of the sound reproduction. Thus, stability of a filtration effect can be ensured.

In the present disclosure, “addition of sound recording buffers”, “writing of buffers in a sound card”, “sound recording callback” and “sound reproduction callback” are equivalent to four pairs of basic groups of ATCG. Progressive combination evolution of sequences is completely consistent with a mode of function calling on two timelines of sound recording and reproduction. Thus, the method is called “double-helix scheduling method for soundcard buffers during sound recording and reproduction”.

Through the above technology, compared with the prior art, beneficial effects of the present disclosure are as follows:

According to the present disclosure, a sound recording callback and writing of buffers in the sound card are used as sound recording frame time consumption, and a sound reproduction callback and addition of sound recording buffers are used as sound reproduction frame time consumption, such that neutralization and equalization are achieved. Duration jitter can be reduced and dynamically tends to be consistent. Two channels of signals of the sound recording and the sound reproduction can be passively dynamically synchronized according to a working principle of a preemption mode of the sound card.

The above examples are merely preferred examples of the present disclosure, and are not intended to limit the present disclosure. Any modifications, equivalent replacements and improvements made within the spirit and principle of the present disclosure should fall within the scope of protection of the present disclosure.

What is claimed is:

1. A double-helix scheduling method for soundcard buffers during sound recording and reproduction, comprising steps as follows:
step 1: preparing N frame buffers for each process of the sound recording and the sound reproduction;
step 2: adding N sound recording buffers in a sound card, and starting the sound recording; and
writing N sound reproduction buffers in the sound card one by one, and then starting the sound playing;
step 3: writing sound reproduction buffers in the sound card in a sound recording callback function;
step 4: adding sound recording buffers in a sound reproduction callback function; and
step 5: finishing the sound recording and the sound reproduction.

2. The double-helix scheduling method for soundcard buffers during sound recording and reproduction according to claim 1, wherein specific instructions in the step 2 are serial in sequence.

3. The double-helix scheduling method for soundcard buffers during sound recording and reproduction according to claim 2, wherein in the step 2, the sound recording buffer is empty, and to be filled; and the sound reproduction buffer is filled by means of a network incoming audio data or through audio file reading and then is written in the sound card.

4. The double-helix scheduling method for soundcard buffers during sound recording and reproduction according to claim 1, wherein a specific process of the step 3 is as follows:
writing N buffers marked with i in a sound reproduction buffer queue in the sound card in the sound recording callback function, wherein i starts from 0, i increases by 1, and i is reset as 0 after being equal to N.

5. The double-helix scheduling method for soundcard buffers during sound recording and reproduction according to claim 4, wherein a specific process of the step 4 is as follows:
adding N buffers marked with j in a sound recording buffer queue in the sound reproduction callback function, wherein j starts from 0, j increases by 1, and j is reset as 0 after being equal to N.

6. The double-helix scheduling method for soundcard buffers during sound recording and reproduction according to claim 5, wherein in the step 3 and the step 4, before the N buffers marked with i in the sound reproduction buffer queue are written in and the N buffers marked with j in the sound recording buffer queue are added in the sound card, a sub-thread is started, and multi-thread scheduling of the sound recording and reproduction is constructed.

7. The double-helix scheduling method for soundcard buffers during sound recording and reproduction according to claim 5, wherein when a signal of real-time sound reproduction is processed, the buffers marked with i in step 3 are required to be taken out for processing before being added in the sound reproduction buffer queue, and a processing result is saved; and
when a signal of real-time sound recording is processed, the buffers marked with j in step 4 are required to be processed before being added in the sound card.

8. The double-helix scheduling method for soundcard buffers during sound recording and reproduction according to claim 5, wherein in the step 3 and the step 4, the sound recording callback function and the sound reproduction callback function each write sound reproduction buffers in or add sound recording buffers in the sound card; and after the sound recording buffers are add in and the buffers are written in the sound card, a corresponding sound recording callback function and sound reproduction callback function are capable of being called; and calls of the sound recording callback function and the sound reproduction callback function, writing of sound reproduction buffers in the sound card in the sound recording callback function, and addition of sound recording buffers in the sound reproduction callback function are repeatedly circulated until the sound recording and the sound reproduction are finished.
